(19) United States
(12) Patent Application Publication
(10) Pub. No.: US 2008/0104169 A1
(43) Pub. Date: May 1, 2008

(54) PROCESSING INITIATE NOTIFICATIONS FOR DIFFERENT MODES OF COMMUNICATION

(75) Inventors: Craig M. Combel, Issaquah, WA (US); Justin M. Maguire, Seattle, WA (US); Mickey Monaghan, Issaquah, WA (US); Joseph T. Fletcher, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/554,558

(22) Filed: Oct. 30, 2006

(51) Int. Cl. G06F 15/16

(52) U.S. Cl. 709/204

(57) ABSTRACT

A method and system for processing initiate notifications for a mode of communication received during a conversation of a current mode of communication is provided. A conversation system coordinates a real-time conversation for a current mode of communication. When the conversation system receives an initiate notification that a user requests to initiate a conversation with the user using a mode of communication different from the current mode of communication, the conversation system displays an indication of the notification in a display space that is outside the context of the current mode of communication. The displayed indication may include status information and controls that allow the user to accept or dismiss the request.

### BACKGROUND

Real-time conversations between conversation participants via their computing devices are becoming increasingly common. Real-time conversations require that the participants be present at their computer systems (e.g., personal digital assistants) and able to respond when a communication is received. Real-time conversations can be conducted using various modes of communication. A common mode of communication for conducting real-time conversations is instant messaging (“IM”). Instant messaging allows participants to send messages and have them received within a second or two by the other participants in the conversation. The receiving participants can then send responsive messages to the other participants in a similar manner. Another common mode of communication for conducting real-time conversations is Voice over Internet Protocol (“VoIP”). VoIP allows participants to communicate audibly in real time in a manner similar to a telephone conversation, except that packets of audio are sent over the Internet rather than via the Public Switched Telephone Network (“PSTN”). Other modes of communication for conducting real-time conversations include video conferencing services, online meeting services, and so on.

The user interface for conducting real-time conversations has been centered on instant message conversations. Since online chats and subsequently instant messaging were the first forms of computer-based real-time conversations, the user interface for these conversations expanded to accommodate new modes of real-time conversations. For example, one user interface for instant messaging notifies the called party when a VoIP call is being initiated by the calling party. When a request to initiate a VoIP conversation is received, the user interface displays within the instant message conversation an indication of the request along with controls for answering or dismissing the request. FIG. 1 is a display page that illustrates the display of an initiate notification within an instant message conversation. The display page 100 includes an instant message window 101. The instant message window includes an instant message conversation window 102 that lists the various messages of the instant message conversation (e.g., “Bill: It is being postponed.”). The instant message conversation window also includes an indication 103 of an incoming VoIP call. The indication includes a status 104 (e.g., “Incoming telephone call”) and controls 105 and 106 for answering or dismissing the call. The user can select the appropriate control to take the desired action with respect to the telephone call. The indication of the VoIP call is thus displayed in the context of the instant message conversation.

The displaying of indications of initiate notifications within an instant message window has several disadvantages. First, the display of the indication may distract the user from the current conversation. This distraction is especially problematic when the telephone call (or other request to initiate a conversation) is not related to the instant message conversation. Second, an instant messaging system may keep a history of all messages of a conversation. If so, the instant message system may store the displayed indication as part of the history even though it may be unrelated to the instant message conversation. Third, if several instant messages are received immediately after the indication of the initiate notification is displayed, the indication may scroll out of view. In such a case, the user needs to remember that the notification was received and then scroll to the indication to take the desired action (e.g., answer the call) by selecting the appropriate control. Fourth, if several indications are received in sequence, they will disrupt the instant message conversation and may cause recent instant messages to scroll out of view.

### SUMMARY

A method and system for processing initiate notifications for a mode of communication received during a conversation of a current mode of communication is provided. A conversation system coordinates a real-time conversation for a current mode of communication between participants who are communicating. When the conversation system receives an initiate notification that a user requests to initiate a conversation with the user using a mode of communication different from the current mode of communication, the conversation system displays an indication of the notification in a display space that is outside the conversation window of the current mode of communication. The displayed indication may include status information and controls that allow the user to accept or dismiss the request. If the user accepts the request to initiate a conversation with another mode of communication, the conversation system may display status information and controls for controlling the ongoing conversation in a display space dedicated to that mode of communication.

The conversation system may allow the display space for displaying indications of initiate notifications to be shared by different modes of communication. The conversation system may provide buttons for scrolling through the indications of initiate notifications for the different modes of communication. Once a user has scrolled to the initiate notification for a desired mode of communication, the user can select a control to initiate or otherwise handle the conversation for that mode of communication.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a display page that illustrates the display of an initiate notification within an instant message conversation.

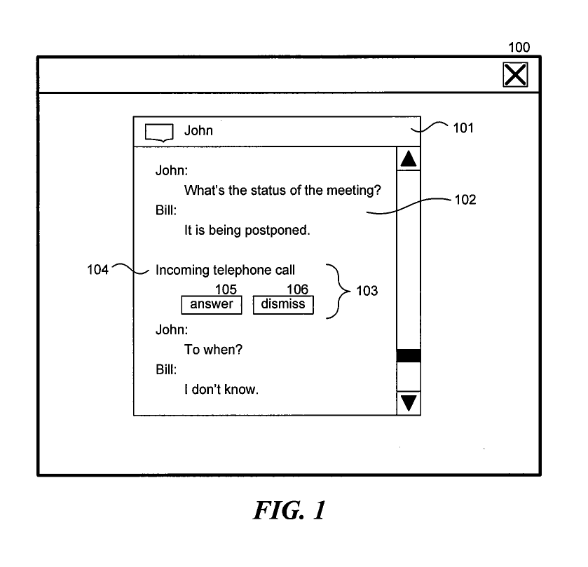

FIG. 2 is a display page that illustrates the display of an indication of an initiate notification in one embodiment.

FIG. 3 is a display page that illustrates the display of controls for controlling a newly initiated conversation in one embodiment.

FIG. 4 is a display page that illustrates the display of controls for controlling a conversation initiated by the user in one embodiment.

FIG. 5 is a display page that illustrates scrolling through initiate notifications for different modes of communication in one embodiment.

FIG. 6 is a block diagram illustrating components of the conversation system in one embodiment.

FIG. 7 is a flow diagram that illustrates the processing of the receive notification component of the conversation system in one embodiment.

FIG. 8 is a flow diagram that illustrates the processing of the display initiate notifications in shared display space component of the conversation system in one embodiment.

FIG. 9 is a flow diagram that illustrates the processing of the scroll shared display space component of the conversation system in one embodiment.

### DETAILED DESCRIPTION

A method and system for processing initiate notifications for a mode of communication received during a conversation of a current mode of communication is provided. In one embodiment, a conversation system coordinates a real-time conversation for a current mode of communication between participants who are communicating. For example, the conversation system coordinates the sending and receiving of messages during a conversation conducted when the current mode of communication is instant messaging. The conversation system allows a participant to enter an instant message, displays the instant message within an instant message conversation window, and sends the instant message to the other participants so that the instant message can be displayed in the instant message conversation window of those participants. When the conversation system receives an initiate notification that a user requests to initiate a conversation with the user using a mode of communication different from the current mode of communication, the conversation system displays an indication of the notification in a display space that is outside the conversation window of the current mode of communication. The displayed indication may include status information and controls that allow the user to accept or dismiss the request. For example, when the current mode of communication is instant messaging and the initiate notification requests to initiate a VoIP conversation, the conversation system may display in a display space dedicated to VoIP conversations an indication that includes the status information that a call is incoming and controls to answer or dismiss the call. The conversation system does not display the indication within the instant message conversation window so that the indication is not intermixed with the messages of the instant message conversation. If the user accepts the request to initiate a conversation with another mode of communication, the conversation system may display status information and controls for controlling the ongoing conversation in the same display space, replacing the previous status information and controls in a separate display space or dedicated to that mode of communication. In this way, the conversation system avoids intermixing notifications to initiate a new conversation within the context of the current mode of communication. Also, the conversation system uses the same display space to display indications of subsequent initiate notifications to minimize the display space used to initiate the conversation for the other mode of communication.

In one embodiment, the conversation system allows the display space for displaying indications of initiate notifications to be shared by different modes of communication. The conversation system may provide buttons for scrolling through the initiate notifications for the different modes of communication. Once a user has scrolled to the initiate notification for a desired mode of communication, the user can select a control to initiate the conversation for that mode of communication. For example, the conversation system may receive, during an instant message conversation, an initiate notification for a VoIP conversation followed by an initiate notification for an online conference. Upon receiving the initiate notification for the VoIP conversation, the conversation system displays an indication of the initiate notification in the display space. Upon receiving the initiate notification for the online conference, the conversation system replaces the currently displayed indication with an indication for the online conference. The conversation system may also add scroll buttons to the display space so that the user can scroll through the initiate notifications for the different modes of communication. If the user scrolls to the initiate notification for a VoIP call and selects a control for answering the VoIP call, the conversation system displays in display space that may be dedicated to VoIP calls for controlling the ongoing VoIP call.

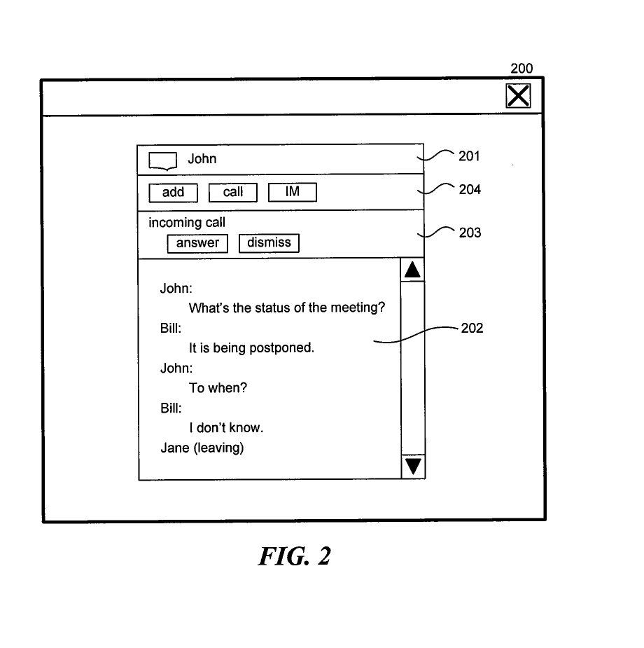

FIG. 2 is a display page that illustrates the display of an indication of an initiate notification in one embodiment. The display page 200 includes an instant message window 201 that includes an instant message conversation window 202, an initiate notification display space 203, and controls 204. The instant message conversation window includes the instant messages of the instant message conversation. The controls 204 allow the user to initiate various modes of communication or to take some action relating to the instant message conversation. The initiate notification display space contains an indication of an initiate notification for an incoming VoIP call. In this example, the indication includes status information (e.g., “incoming call”) and controls for answering or dismissing the incoming VoIP call.

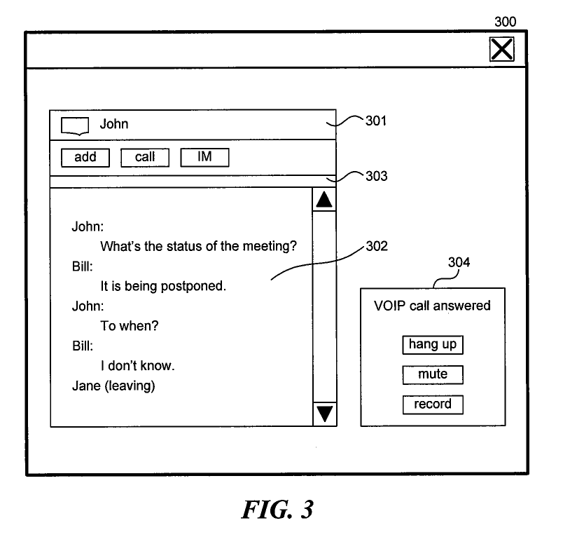

FIG. 3 is a display page that illustrates the display of controls for controlling a newly initiated conversation in one embodiment. The display page 300 includes an instant message window 301, an instant message conversation window 302, an initiate notification display space 303, and a VoIP call window 304. In this example, the user when presented with the display page of FIG. 2 selected the answer control to answer the VoIP call. The conversation system then removed the indication of the initiate notification and created the VoIP call window as dedicated display space for status information (e.g., “call answered”) and controls for controlling the answered VoIP call. The controls include a control to hang up the call, mute the incoming audio of the call, and record the call. Other controls may be displayed to allow greater control of the call. For example, a control may be displayed to send the audio to speakers other than those of a headset.

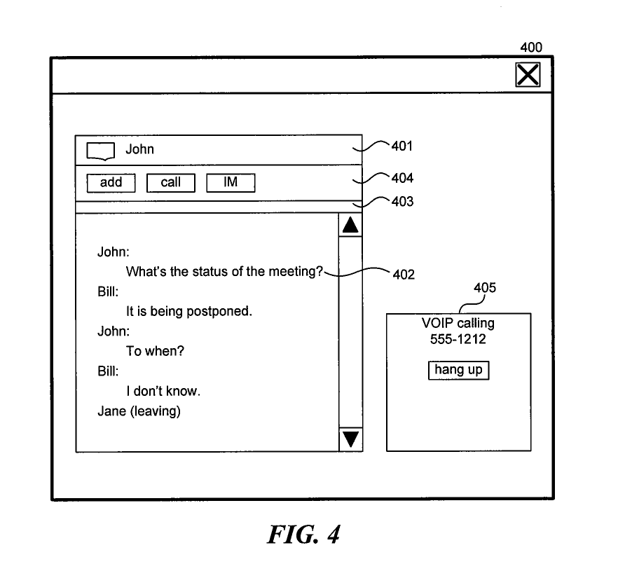

FIG. 4 is a display page that illustrates the display of controls for controlling a conversation initiated by the user in one embodiment. The display page 400 includes an instant message window 401 that includes an instant message conversation window 402, an initiate notification display space 403, controls 404, and VoIP call window 405. The instant message conversation window includes the instant messages of the instant message conversation. The controls 404 allow the user to initiate various modes of communication or to take some action relating to the instant message conversation. In this example, the user selected the control (e.g., the “call” button) to initiate a VoIP call. The conversation system then displayed status information and controls for controlling the VoIP in the dedicate display space—the VoIP call window. Since the VoIP is in the process of being initiated, the conversation system displays an indication of the number being called along with a control to hang up the call. When the called party answers the call, the conversation system displays controls in the VoIP call window for controlling the VoIP call as illustrated by the VoIP call window 304 of FIG. 3.

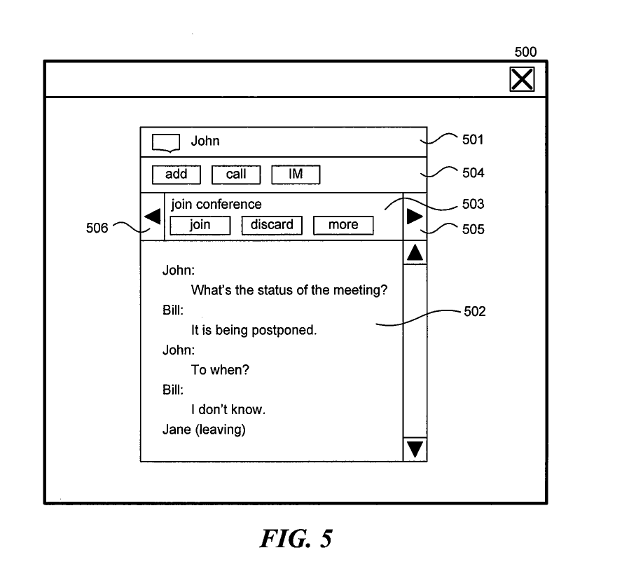

FIG. 5 is a display page that illustrates scrolling through initiate notifications for different modes of communication in one embodiment. The display page 500 includes an instant message window 501 that includes an instant message conversation window 502, an initiate notification display space 503, and controls 504. The initiate notification display space includes a next button 505 and a previous button 506 for scrolling through the initiate notifications for the different modes of communication. As the user selects the next or previous buttons, the conversation system displays the initiate notifications for the next or previous modes of communication. The conversation system may include different sets of initiate notifications for different conversations for the same mode of communications. For example, if the user has received two initiate notifications for two different online conferences, then conversation system may display the initiate notifications for the two different conferences as the user scrolls through the controls of the control display space. The status information displayed in the control display space allows the user to identify to which online conference the initiate notification applies.

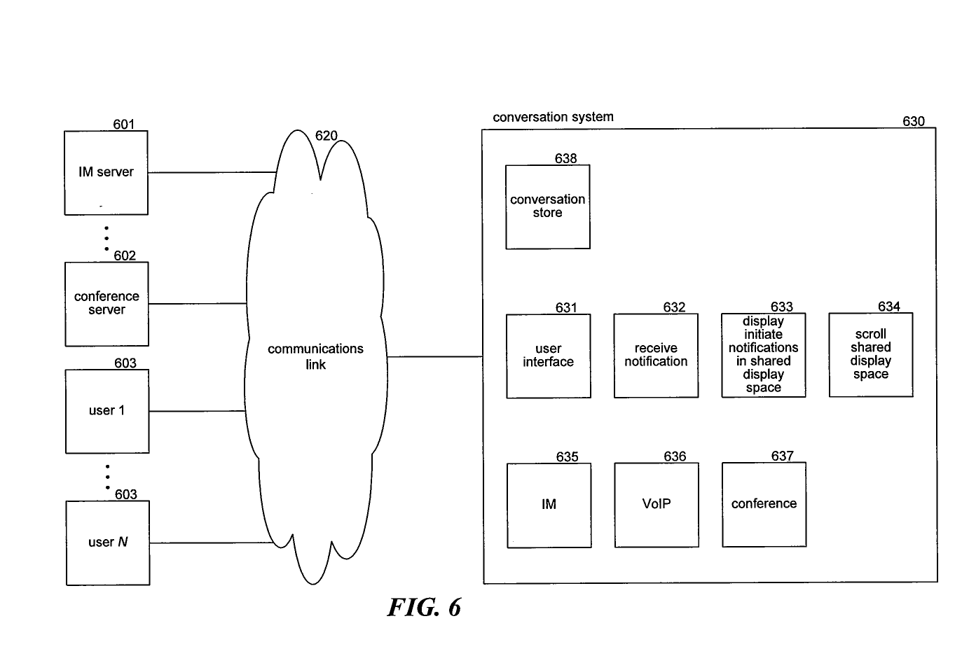

FIG. 6 is a block diagram illustrating components of the conversation system in one embodiment. The conversation system 630 is implemented on a computing device that is connected via a communications link 620 to various servers 601, 602 and user computing devices 603. The servers may include an instant message server, a presence server, an online conference server, and so on. The user computing devices may include laptop computers, cell phones, personal digital assistants, and so on. The conversation system may include a user interface component 631, a receive notification component 632, a display initiate notifications in shared display space component 633, and a scroll shared display space component 634. The conversation system also includes conversation components such as an instant message component 635, a VoIP component 636, and an online conference component 637. The user interface component interacts with the conversation components to initiate conversations for various modes of communication. The user interface component may store a history of each conversation in a conversation store 638. The receive notification component is invoked when the notification relating to a conversation is received via communications link 620. The display initiate notifications controls in shared display space component is invoked to display indications of notifications in the shared display space. The scroll shared display space component is invoked to scroll through the initiate notifications of the shared display space.

The computing device on which the conversation system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the conversation system, which means a computer-readable medium contains the instructions. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the conversation system may be implemented in various operating environments that include personal computers, server computers, hand-held or laptop devices, multiprocessor systems, microprocessor-based systems, programmable consumer electronics, digital cameras, network PCs, minicomputers, mainframe computers, cell phones, personal digital assistants, smart phones, personal computers, programmable consumer electronics, distributed computing environments that include any of the above systems or devices, and so on.

The conversation system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

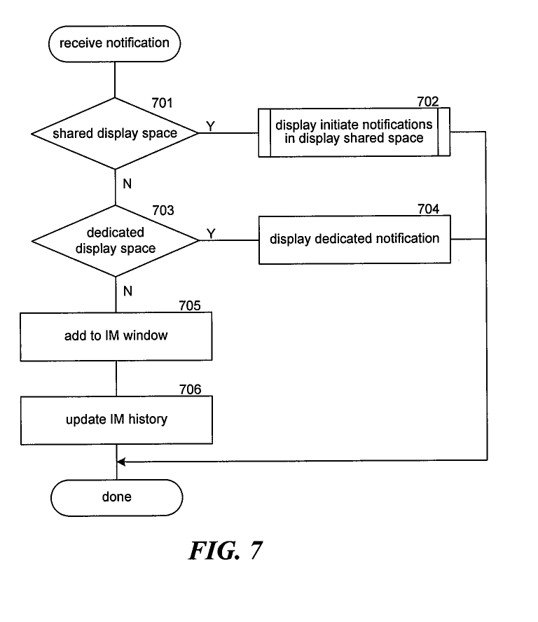

FIG. 7 is a flow diagram that illustrates the processing of the receive notification component of the conversation system in one embodiment. The component is invoked when a notification is received relating to a conversation to be initiated. Each mode of communication may have a dedicated display space for displaying its controls for controlling an initiated conversation. In decision block 701, if the notification is for a mode of communication that shares display space, then the component continues at block 702, else the component continues at block 703. In block 702, the component invokes the display initiate notifications in shared display space component to display an indication of the notification in the shared display space and then completes. In decision block 703, if the notification is for a mode of communication that has dedicated display space for displaying initiate notifications, then the component continues at block 704, else the component continues at block 705. In block 704, the component displays the initiate notification in the dedicated display space and then completes. In block 705, the component updates the instant message history window (assuming instant message is the current mode of communication) to indicate the newly received notification. In block 706, the component updates the instant message history in the conversation store and then completes.

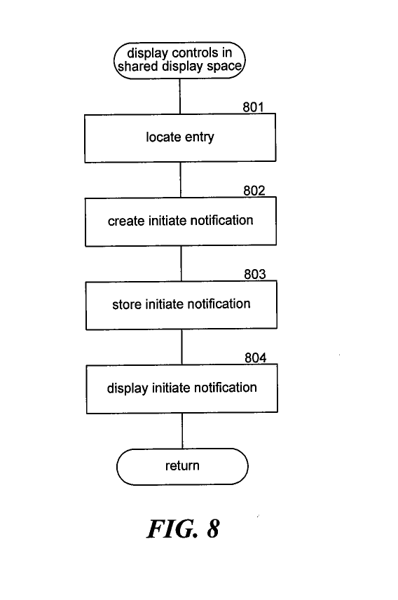

FIG. 8 is a flow diagram that illustrates the processing of the display initiate notifications in shared display space component of the conversation system in one embodiment. The component adds status information and controls for the mode of communication to the list to be displayed in the shared display space. In one embodiment, the conversation system may manage the controls itself and then invoke the appropriate conversation component for controlling an initiate conversation. In block 801, the component locates the entry for the mode of communication in the list or adds an entry if none can be located. In block 802, the component create an initiate notification with controls corresponding to the received notification. In block 803, the component updates the entry of the list to indicate the initiate notification. In block 804, the component displays the initiate notification with controls and then returns.

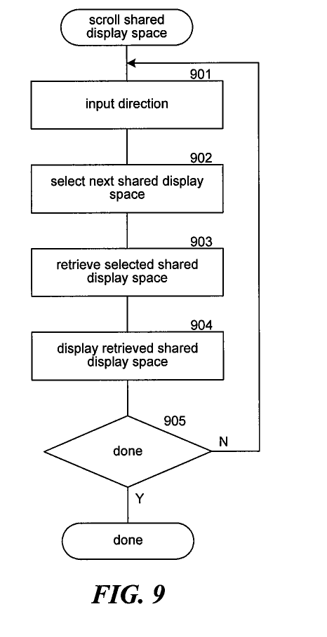

FIG. 9 is a flow diagram that illustrates the processing of the scroll shared display space component of the conversation system in one embodiment. The component allows a user to scroll through the initiate notification that have not been acted upon for the various modes of communication that are displayed within the shared display space. In block 901, the component inputs the direction of scroll. In block 902, the component selects the next or previous entry of the list for the input direction. In block 903, the component retrieves the initiate notification of the selected entry. In block 904, the component displays the retrieved initiate notification in the shared display space. In decision block 905, if the user is done scrolling, then the component completes, else the component loops to block 901 to the input the next direction of scroll.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, the conversation system may automatically remove an initiate notification from the shared display space when the user has not acted upon the initiate notification for some period or when the initiate notification becomes stale (e.g., an incoming call is terminated). Accordingly, the invention is not limited except as by the appended claims.

I/We claim:

1. A method in a computing device for handling initiate notifications for modes of communication received during an instant message conversation, the method comprising:
displaying an instant message window, the instant message window including an instant message conversation window containing instant messages of the instant message conversation;
receiving an initiate notification for a mode of communication other than instant messaging; and
displaying an indication of the received initiate notification in a display space outside of the instant message conversation window so that the indication is not displayed in context of the instant message conversation.

2. The method of claim 1 wherein the indication of the received notification includes controls relating to the initiate notification of the mode of communication other than instant messaging.

3. The method of claim 2 including after a conversation of the mode of communication is initiated, displaying within a dedicated display space controls for controlling the initiated conversation.

4. The method of claim 1 wherein when multiple initiate notifications for modes of communication other than instant messaging are received, displaying an indication for one of the multiple initiate notifications at a time in the display space.

5. The method of claim 4 including scrolling in the display space through the indication for each of the multiple initiate notifications.

6. The method of claim 1 including upon receiving a notification for the instant message conversation, displaying an indication of the received notification in the instant message conversation window.

7. The method of claim 1 including storing a history of the instant messages of the instant message conversation without an indication of the initiate notification.

8. A computer-readable medium encoded with computer-executable instructions for controlling a computing device to process initiate notifications for initiating modes of communication, by a method comprising:
displaying a conversation window for a first mode of communication, the conversation window containing a conversation of the first mode of communication;
receiving an initiate notification for a second mode of communication different from the first mode of communication; and
displaying an indication of the received initiate notification in a display space outside of the conversation window of the first mode of communication so that the indication is not displayed in context of the conversation of the first mode of communication.

9. The computer-readable medium of claim 8 wherein the indication of the received notification includes a control for accepting the initiate notification to initiate a conversation in the second mode of communication.

10. The computer-readable medium of claim 9 including after a conversation of the second mode of communication is initiated, displaying within a dedicated display space controls for controlling the initiated conversation.

11. The computer-readable medium of claim 8 wherein the first mode of communication is instant messaging and the second mode of communication is Voice over Internet Protocol.

12. The computer-readable medium of claim 8 wherein when multiple initiate notifications for modes of communication other than the first mode of communication are received, displaying an indication for one of the multiple initiate notifications at a time in the display space.

13. The computer-readable medium of claim 12 including scrolling in the display space through the indication for each of the multiple initiate notifications.

14. The computer-readable medium of claim 8 wherein when multiple conversations for multiple modes of communication other than the first mode of communication are initiated, displaying controls for each mode of communication in a dedicated display space.

15. The computer-readable medium of claim 8 including upon receiving a notification for the conversation of the first mode of communication, displaying an indication of the received notification in the conversation window for the first mode of communication.

16. The computer-readable medium of claim 8 including storing a history of the conversation of the first mode of communication without an indication of the initiate notification of the second mode of communication.

17. The computer-readable medium of claim 8 wherein the first mode of communication is instant messaging and the second mode of communication is Voice over Internet Protocol; wherein the indication of the received notification includes a control for accepting the initiate notification to initiate a conversation of the second mode of communication; including after a conversation of the second mode of communication is initiated, displaying within a dedicated display space controls for controlling the initiated conversation; and including storing a history of the conversation of the first mode of communication without an indication of the initiate notification of the second mode of communication.

18. A computing device for handling initiate notifications for modes of communications received during an instant message conversation, comprising:
a component that displays an instant message context containing instant messages of the instant message conversation;
a component that receives initiate notifications for modes of communication other than instant messaging;
a component that displays an indication of a received initiate notification in a display space outside of the instant message context, the displayed indication including a control for accepting the initiate notification to initiate a conversation of the mode of communication other than instant messaging; and
a component that, after a conversation of the mode of communication is initiated, displays within a display space controls for controlling the initiated conversation.

19. The computing device of claim 18 wherein the display space with controls controlling is a dedicated display space.

20. The computing device of claim 18 wherein notifications for the modes of communication other than instant messaging are not displayed within the instant message context.
